(19) United States
(12) Patent Application Publication
(10) Pub. No.: US 2001/0042014 A1
(43) Pub. Date: Nov. 15, 2001

(54) System and method of providing communication between a vendor and client using an interactive video display

(76) Inventors: Brian C. Lowry, Emlenton, PA (US); Jerald F. Lowry, Pittsburgh, PA (US); Joseph Marnell, Sewickley, PA (US); Evan Wimer, Pittsburgh, PA (US)

Correspondence Address: Attn: James M. Singer, PEPPER HAMILTON LLP, 50th Floor, 500 Grant Street, Pittsburgh, PA, 15219, US

(21) Appl. No.: 09/766,564

(22) Filed: Jan. 19, 2001

Related U.S. Application Data
(63) Continuation-in-part of application No. 09/570,999, filed on May 15, 2000.

(51) Int. Cl. G06F 17/60

(52) U.S. Cl. 705/14

(57) ABSTRACT

A method and system for providing communication between a vendor and a client includes a large screen display connected into a network that enables client/vendor communication. Through the network, the vendor's server provides the desired content to the display. For a network of displays, the content may be the same on all displays or unique to each display. The display includes a transmitter and a receiver. Clients interact with the display using a wireless communications or computing device.

### CLAIM OF PRIORITY

This application claims priority to and is a continuation-in-part of Utility U.S. patent application Ser. No. 09/570,999, entitled “Apparatus and Method for Direct Interaction between Video Display Devices and Hand-Held or Body-Mounted Computing or Communications Devices,” which is incorporated herein by reference in its entirety.

### BACKGROUND OF THE INVENTION

Currently, contact between product and service vendors and their respective clients are generally restricted to one-way communication through media such as static billboards, radio and television advertising, and print advertising. E-commerce and the Internet (world wide web) have enabled two-way vendor/client communication by allowing the client to express preferences and order goods and services from the vendor nearly instantaneously. Through e-commerce, vendors are now able not only to advertise their products but also to collect important information about their clients' preferences. This is an important breakthrough for both vendors and consumers. However, this type of interactive communication depends upon clients having access to computers linked to the Internet, and limits both the number of consumers reached by the vendor and the circumstances under which they can interact.

In the arena of retail marketing, it is becoming increasingly important for vendors to understand their clients' needs and for each client to be able to express preferences in regard to product offers he or she would like to receive. Current methods used by vendors to collect client information (such as telephone surveys and survey cards) are cumbersome, slow, and costly. Even fewer ways exist for clients to provide product and service preferences to vendors. Nearly all existing two-way communication takes place in the home or office by mail, telephone and/or the Internet. This limits the marketing potential of a given product or service by failing to take advantage of the significant amount of time that clients spend in public venues such as airports, shopping malls, hospitals, universities, sports arenas, etc. There is a need for a way to provide confidential client/vendor communication in public venues.

Large screen displays (“LSDs”) promise to increase both vendor exposure to larger numbers of potential customers. Although the presence of LSDs in public venues such as sports arenas has become common, many other possible venues have been neglected. Further, most current public-venue advertising is static, and therefore non-responsive to clients' ever-changing needs and desires. Because of its static nature, much current advertising is passed over by clients. The limited amount of current dynamic advertising lacks any capability for responding to orders for goods and services, providing customized information, or providing services for the client. Internet kiosks, which exist in limited areas, are small-scale and limited to single users who must approach the kiosk closely. Thus, there is a need for a way to attract consumers to an LSD and make it interactive from a greater distance.

Current LSDs are relegated to the dissemination of one-way information. These include static billboards, lighted displays, liquid crystal displays (“LCDs”), light emitting diode (“LED”) displays, plasma displays, video walls and other display technologies. However, none of these display technologies enables client interactivity, thus severely limiting vendor marketing potential and client feedback. If the technology driving LSDs were to become both more applicable to a greater variety of environments and also enabled for interaction with the viewers of LSDs, the market could be expanded considerably. Advertisers, on-site customers, and all manner of clientele would benefit considerably from being able to interact more directly with the content displayed. By developing enabling technology for interactive LSDs, considerable value can be added to the LSD market. Thus, there is a need for an LSD that enables viewer interaction with the video display.

### SUMMARY OF THE INVENTION

A preferred embodiment of the present invention features an LSD whose displayed content can be modified by a vendor and can be connected to a network that enables client/vendor communication. The vendor's server is connected to a network such as the Internet or an intranet as is a central display controller. Through the network, the vendor's server provides the desired content to the central display controller, which directs the content to a single display or a network of displays. For a network of displays, the content may be the same on all displays or unique to each display. Clients interact with the display using a wireless communications or computing device such as a personal digital assistant or PDA (e.g., a PalmPilot®) having communications capability, a laptop computer having communications capability, a wireless or cellular phone, an onboard computer system having communications capabilities, an onboard communication person, or a wearable internet appliance (“WIA”). In this way, the client and vendor are put into direct communication. Clients may conduct a wide variety of transactions through the LSD, including ordering goods and/or services, making travel or other reservations, accessing e-mail services, accessing paging services, and retrieving public information such as flight schedules or business hours. The vendor may charge a fee for any or all of these transactions. Vendors may request and receive information directly from the client such as billing and shipping information and product preferences.

In accordance with another embodiment, the invention features a business method of operation for client/vendor interaction using an LSD and includes the following: First, a vendor displays content on an LSD. Second, a client communicates with the LSD using a wireless communication or computing device such as those described above. Third, the LSD communicates back to the client. Fourth, the vendor initiates data transfer/storage. Fifth, the client initiates data transfer/storage. Sixth, the client terminates the communications link.

In accordance with another embodiment, the invention features a business method of operation for downloading electronic coupons from an LSD. This method includes the following steps: First, a vendor displays images of merchandise, promotional offer(s), electronic coupon(s), and download instructions. Second, a client views merchandise, promotional offer(s), electronic coupon(s), and download instructions. Third, the client establishes a communications link to the LSD using a wireless hand-held or wearable computing or communications device such as a PDA or WIA. Fourth, the vendor communicates back to the client via the LSD. Fifth, the client downloads the electronic coupon into PDA or WIA data storage memory. Sixth, the client terminates the communications link.

In accordance with another embodiment, the invention features a business method of operation for ordering goods and/or services from an LSD and includes the following steps: First, a vendor displays images of merchandise and/or services offered, and ordering instructions. Second, a client views the merchandise and/or services offered, promotional offers (if any), and ordering instructions. Third the client establishes a communications link to the LSD using a wireless hand-held or wearable computing or communications device such as a PDA or WIA. Fourth, the client orders the merchandise and/or services. Fifth, the client submits payment and shipping information through the PDA or WIA. Sixth, the client terminates the communications link.

In accordance with another embodiment, the invention features a business method of operation for downloading information from an LSD and includes the following steps: First, a vendor displays electronic information and download instructions. Second, a client views the information and download instructions. Third, the client establishes a communications link to the LSD using a wireless hand-held or wearable computing or communications device such as a PDA or WIA. Fourth, the LSD communicates back to the client. Fifth, the client downloads electronic information into the PDA or WIA data storage memory. Sixth, the client terminates the communications link.

In accordance with another embodiment, the invention features a business method of operation for conducting electronic surveys and includes the following steps. First, a vendor displays electronic survey and survey completion information. Second, a client views the survey and survey completion instructions. Third, the client establishes a communications link to the LSD using a wireless hand-held or wearable computing or communications device such as a PDA or WIA. Fourth, the client completes and submits a survey using the PDA or WIA. Fifth, the client terminates the communications link.

In accordance with another embodiment, the invention features a business method of operation for accessing e-mail and/or accessing the Internet and includes the following steps: First, a vendor displays Internet access instructions. Second, a client views the Internet access instructions. Third, the client establishes a communications link to the LSD using a wireless hand-held or wearable computing or communications device such as a PDA or WIA. Fourth, the client accesses a personal e-mail exchange server or the Internet. Fifth, the client terminates the communications link.

In accordance with another embodiment, the invention features a business method of operation for accessing and using paging services and includes the following steps: First, a vendor displays paging service access instructions. Second, a client views the paging service access instructions. Third, the client establishes a communication link to the LSD using a wireless hand-held or wearable computing or communications device such as a PDA or WIA. Fourth, the client accesses a paging service by submitting an identifier for a paged party. Fifth, the identifier of the paged party is disseminated over an LSD network. Sixth, the paged party establishes a communications link to display using a wireless hand-held or wearable computing or communications device such as a PDA or WIA. Seventh, the paged party responds. Eighth, the LSD terminates display of the paged party identifier. Ninth, both parties terminate communications links.

### BRIEF DESCRIPTION OF THE DRAWINGS

FIG. 1 illustrates the primary components of an interactive large-screen display system.

FIG. 2 illustrates the secondary components of an interactive large-screen video display system.

FIG. 3 is a flow diagram of a method of operation for a generalized client/vendor interaction using a large screen display.

FIG. 4 is a flow diagram of a method of operation for downloading an electronic coupon.

FIG. 5 is a flow diagram of a method of operation for ordering goods and/or services.

FIG. 6 is a flow diagram of a method of operation for downloading electronic information from a large screen interactive display.

FIG. 7 is a flow diagram of a method of operation for conducting an electronic survey.

FIG. 8 is a flow diagram of a method of operation for accessing e-mail and/or accessing the Internet.

FIG. 9 is a flow diagram of a method of operation for accessing and using paging services.

### DETAILED DESCRIPTION OF PREFERRED EMBODIMENTS OF THE INVENTION

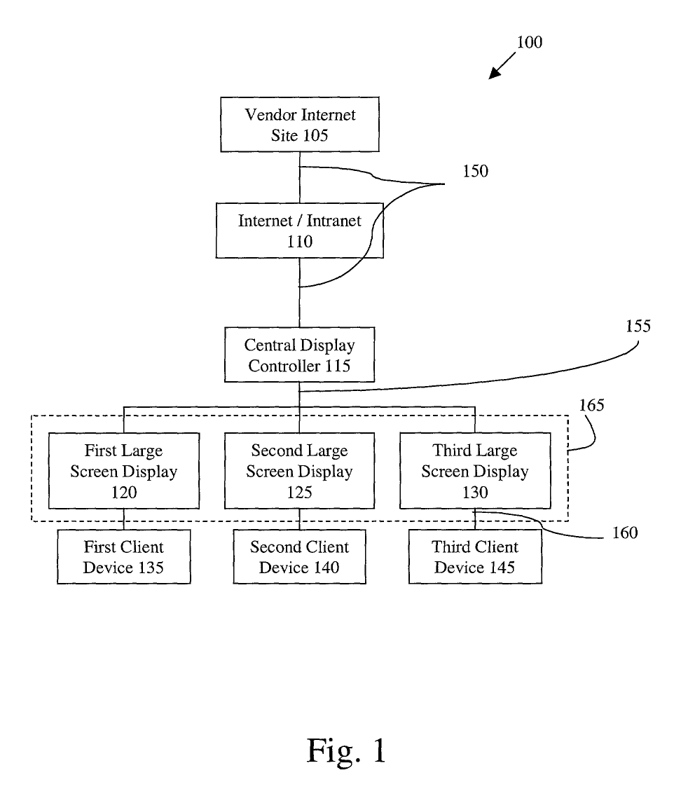

In a preferred embodiment, the present invention is a method of doing business using an interactive large screen video display in a public venue, in which the transaction is both confidential and secure for both the client and the vendor. Referring to FIG. 1, an interactive large-screen display system 100 facilitates direct interaction between large-screen video display devices and hand-held or wearable or other wireless communication devices. Interactive large-screen display system 100 includes a vendor Internet site 105, an Internet/intranet 110, a central display controller 115, a display network 165, a first large-screen display (LSD) 120, a second LSD 125, a third LSD 130, a first client device 135, a second client device 140, and a third client device 145. Interactive large-screen display system 100 also includes network communication pathways 150, display communication pathways 155, and wireless communication pathways 160. Although FIG. 1 illustrates a display network 165 comprised of three LSDs, this illustration is meant to be exemplary, and display network 165 may contain any number of LSDs Optionally, the network may comprise a single LSD.

Vendor display, such as a video presentation or Internet site 105, and central display controller 115 are electrically connected to Internet/intranet 110 via network communication pathways 150. LSDs 120, 125, and 130 are electrically connected to central display controller 115 via display communication pathways 155. Client devices 135, 140, and 145 are connected to LSDs 120, 125, and 130 respectively, via wireless communication pathways 160, such as an infrared link, cellular communication, or digital communication. LSDs 120, 125, and 130 are integral to display network 165.

In operation, vendor Internet site 105 provides content to a communications network such as Internet/intranet 110 through network communication pathways 150. This content may include items such as electronic advertising, images and text relevant to vendor products and services, vendor promotional offers, or any information deemed by the vendor to be useful to the client. The content may consist of single or multiple concurrent information streams. A communications network such as Internet/intranet 110 transfers the content via network communication pathways 150 to central display controller 115. Central display controller 115 directs the information to display network 165 via display communication pathways 155. Display network 165 includes LSDs 120, 125, and 130, which represent a network of linked displays. Display network 165 may contain more or fewer displays than illustrated in FIG. 1. These electronically-linked displays may be contiguous (e.g. in the same room or building) or separated by large distances (anywhere in the world). Central display controller 115 may customize the content provided from vendor Internet site 105 for each display by providing different content files such as animations or movies obtained via communication network such as Internet/intranet 110 from vendor display such as Internet site 105. Client devices 135, 140, and 145 communicate with LSDs 120, 125, and 130 via wireless communication pathways 160. Client devices 135, 140, 145 include apparatus such as WAP (Wireless Application Protocol)-enabled cellular devices (e.g., the Nokia model 6210 cellular telephone), Bluetooth®-enabled devices such as PDAs (Personal Digital Assistant, such as a PalmPilot®) or WIAs (Wearable Internet Appliances), or any hand-held, wrist-mounted, head-mounted, or otherwise wearable computing or communications device. These devices may be personally owned, mounted on stands near individual displays, or dispersed within view of display network 165. Optionally the device may stand alone, without human intervention, thus making the “client” an object rather than a person. For example, a transponder chip may be embedded in a “smart card,” a product on a shelf, or any item in order to provide the item with wireless communication capability. If client devices are not personally owned, a client may enter personal information (rather than have information automatically uploaded). Information storage may occur if a client requests to have information e-mailed to a home computer. Wireless communication pathways 160 may be ultrasonic, infrared, visible, or radio-frequency electromagnetic radiation, or any other means of wireless communication. Information provided by client devices 135, 140, and 145 is received by LSDs 120, 125, and 130, routed back through central display controller 115 and through Internet/intranet 110, and terminates at vendor Internet site 105 where it is processed and stored.

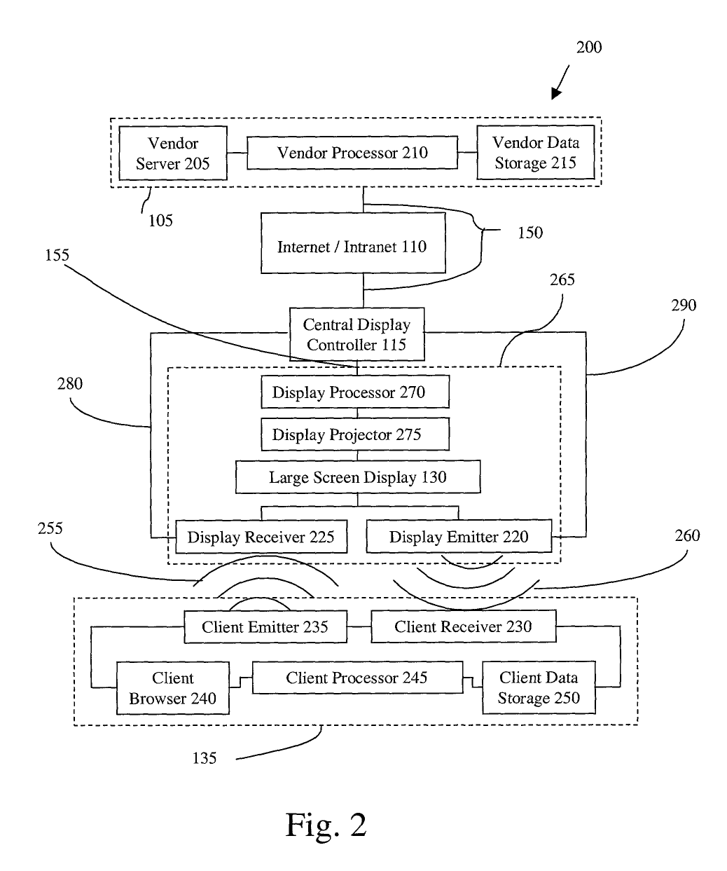

FIG. 2, illustrates an interactive large-screen video display system 200, which further details the system shown in FIG. 1. Interactive large-screen video display system 200 contains a vendor Internet site 105 that further includes a vendor server 205, a vendor processor 210, and vendor data storage 215. Interactive large-screen video display system 200 also includes a network such as the Internet or an intranet 110, a central display controller 115, and one or more large-screen display systems 265. Each large-screen display system 265 further includes a display processor 270, a display projector 275, an LSD 130, a display emitter 220, and a display receiver 225. Interactive large-screen video display system 200 also includes a client device 135 that further includes a client receiver 230, a client emitter 235, a client browser 240, a client processor 245, and client data storage 250. Interactive large-screen video display system 200 also includes a client-to-vendor wireless communication pathway 255, a vendor-to-client wireless communication pathway 260, a client network communication pathway 280, and a vendor network communication pathway 290.

Vendor Internet site 105 and central display controller 115 are electrically connected to Internet/intranet 110 via network communication pathways 150. Vendor server 205, vendor processor 210, and vendor data storage 215 are connected electrically together into the vendor's central processing unit (not shown). Large-screen display system 265 is electrically connected to central display controller 115 via display communication pathway 155. Display processor 270, display projector 275, LSD 130, display emitter 220, and display receiver 225 are electrically connected together and integral to large-screen display system 265. Client receiver 230 is connected to display emitter 220 via vendor-to-client wireless communication pathway 260. Client emitter 235 is connected to display receiver 225 via client-to-vendor wireless communication pathway 255 such as an infrared link. Display emitter 220 is electrically connected directly to central display controller 115 via vendor network communication pathway 290, and display receiver 225 is electrically connected directly to central display controller 115 via client network communication pathway 280. Client receiver 230, client emitter 235, client browser 240, client processor 245, and client data storage 250 are all connected electrically together within the client's hand-held or wearable wireless computing or communications device 135. Client device 135 is connected to the system wirelessly by client emitter 235 and client receiver 230.

In operation, content stored in vendor data storage 215 is processed by vendor processor 210 and placed on vendor server 205 where it is transferred to Internet/intranet 110 via network communication pathway 150. Internet/intranet 110 transfers the information via network communication pathway 150 to central display controller 115. Central display controller 115 directs a portion of the content to large-screen display system 265 via display communications pathway 155. Within large-screen display system 265, this content is processed by display processor 270 and delivered to LSD 130 via display projector 275. Additional content received by central display controller 115 is coordinated with display content and directed via vendor communication pathway 290 to display emitter 220, which radiates a wireless communication signal 260 that is received by client device 135 through client receiver 230. The information radiated by display emitter 220 is then processed by client processor 245 and stored in client data storage 250. Client browser 240 includes software that allows client device 135 to access the Internet/intranet 110 via display receiver 225, client-to-vendor wireless communication pathway 255, client network communications pathway 280, and central display controller 115. Display receiver 225 receives information radiated by client emitter 235 via client-to-vendor wireless communication pathway 255. This information is routed back to the Internet/intranet 110 via client network communication pathway 280 and central display controller 115, and terminates at vendor server 205 where it is processed by vendor processor 210 and stored in vendor data storage 215.

LSD 130 is preferably a fiber optic display. Fiber optic displays are durable, relatively inexpensive, capable of operating in extreme environments, and require minimal maintenance. Alternatively, LSD 130 may be an LED display, incandescent lamp display, video wall, laser display, LCD display, CRT (Cathode Ray Tube) display, plasma display, or any other apparatus for displaying images scaled for use in a public venue.

Large screen display system 265 can be configured with a plurality of emitters 220 and receivers 225 so as to allow multiple clients to use the system simultaneously. Certain types of wireless communication devices, primarily those employing infrared electromagnetic radiation such as a basic model PalmPilot®, may have a limited range of communication. Without a relay station to amplify and resend an infrared wireless communication signal, client device 135 must be within 0.5 to 20 feet for communication with large screen display system 265. However, using a relay station (or combination of relay stations) removes any practical limit to the distance between client device 135 and large screen display system 265. Generally, wireless communication devices employing ultrasonic emitters and receivers, or employing electromagnetic radiation at visible or radio frequency wavelengths, are not limited to so short a range, and do not require a relay station.

Large screen display system 265 may present multi-screen images, i.e., numerous images may be presented simultaneously on LSD 130 disposed into different sectors of the display area. For example, this may allow for streaming information (such as stock quotations) in one area of LSD 130 and simultaneous advertising images in other areas of LSD 130.

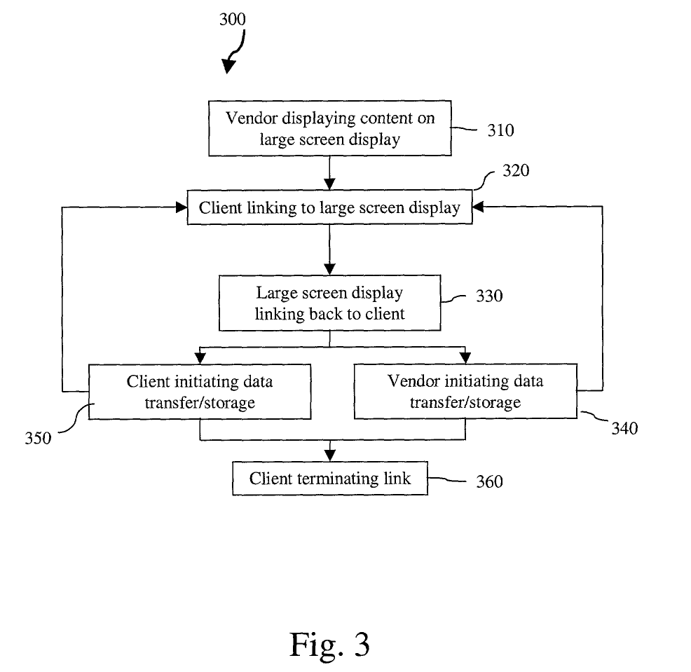

FIG. 3 illustrates a method of operation for a generalized client/vendor interaction using a large screen display. LSD interaction method 300 includes the following steps:

Step 310: Vendor Displays Content on Large Screen Display (LSD)

In step 310, the vendor transfers and displays electronic content on a large screen display. This content may include electronic advertising, images, and text relevant to vendor products and services, vendor promotional offers, or any information deemed by the vendor to be useful to the client.

Step 320: Client Links to LSD

In step 320, the client initiates communication with the LSD using a hand-held computing or communications device such as a WAP (Wireless Application Protocol)-enabled cellular device (e.g., Nokia model 6210 cellular telephone), a PDA (Personal Digital Assistant, such as a PalmPilot®), or other hand-held, wrist-mounted, head-mounted, or otherwise wearable computing or communications device.

Step 330: LSD Links Back to Client

In step 330, the LSD initiates communication back to the client using the same type of wireless communication pathway initiated by the client, which may be infrared, ultrasonic, visible or radio frequency electromagnetic radiation, or any other means of wireless communication.

Step 340: Vendor Initiates Data Transfer/Storage

In step 340, the vendor initiates a transfer of data (such as a software module or electronic coupon) to the client. Additionally, the vendor may receive and store data transmitted by the client (such as a user profile or email address).

Step 350: Client Initiates Data Transfer/Storage

In step 350, the client initiates a transfer of data (such as personal preference data or product ordering information) to the vendor. Additionally, the client may receive and store data transmitted by the vendor (such as flight schedules or an electronic map).

Step 360: Client Terminates Link

In step 360, the client terminates communication with the LSD.

The possible uses for such a system are diverse. They may include, but are not limited to, reserving or renting a car, gathering local or non-local weather information, paging a party in an airport, sending and retrieving personal e-mail, ordering merchandise, accessing the Internet, receiving streaming information (such as stock quotations), conducting surveys, reserving accommodations locally or world-wide, electronic flight check-in and downloading of boarding pass, and downloading electronic coupons redeemable at point-of-purchase.

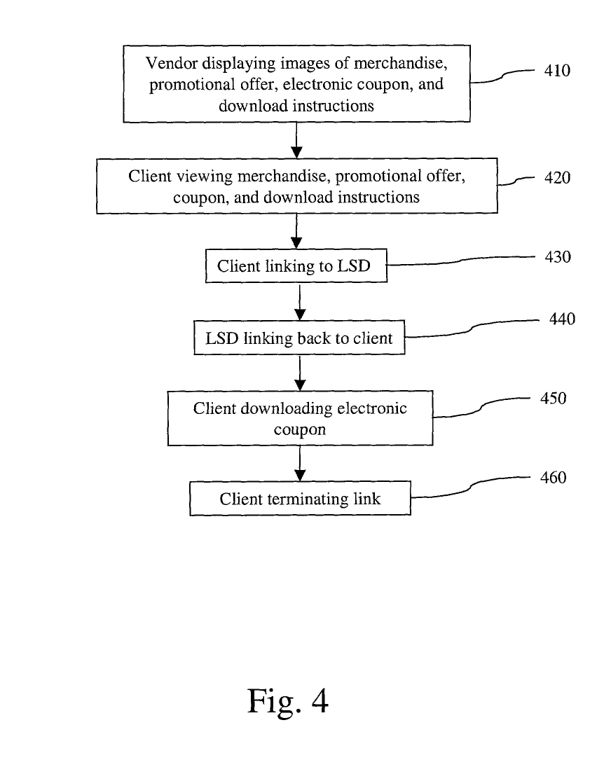

FIG. 4 illustrates an exemplary method of operation for downloading an electronic coupon from an interactive large screen display. This method includes the following steps:

Step 410: Vendor Displays Images and/or Text Depicting Merchandise or Service Offer, Promotional Offer, Electronic Coupon, and Download Instructions

In step 410, the vendor transmits and displays images and text depicting merchandise or service offers and an associated promotional offer. The transmitted images and text further serve to explain the electronic coupon and provide instructions to the client for downloading the coupon.

Step 420: Client Views Merchandise or Service Offered, Promotional Offer, Electronic Coupon, and Download Instructions

In step 420, the client views images of the merchandise or service offered, images or text describing the electronic coupon, and reads the instructions for downloading the coupon.

Step 430: Client Links to LSD

In step 430, the client initiates communication with the LSD using client-to-vendor wireless communication pathway 255 via a hand-held or wearable communication or computing device such as a PDA or WIA that is enabled for wireless communication.

Step 440: LSD Links Back to Client

In step 440, the LSD initiates communication back to the client using the same type of wireless communication pathway initiated by the client, which may be infrared, ultrasonic, visible or radio frequency electromagnetic radiation, or any other means of wireless communication.

Step 450: Client Downloads Electronic Coupon

In step 450, the client downloads the electronic coupon and stores it (for example) in a PDA or WIA data storage memory.

Step 460: Client Terminates Link

In step 460, the client terminates the link with the LSD.

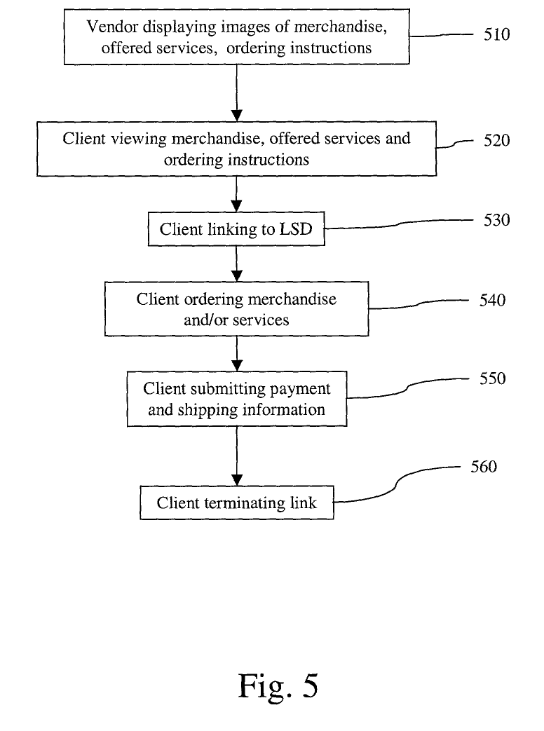

FIG. 5 illustrates an exemplary method of operation for ordering goods and/or services via a large-screen interactive display. This method includes the following steps:

Step 510: Vendor Displays Text and/or Images of Merchandise and/or Services Offered, Promotional Offer(s), and Ordering Instructions

In step 510, the vendor transmits and displays images and text that describe the merchandise and/or services offered, any promotional offers, and the ordering instructions.

Step 520: Client Views Merchandise and/or Services Offered, Promotional Offer, and Ordering Instructions

In step 520, the client views the goods and/or services offered, views the promotional offer(s), and reads the ordering instructions.

Step 530: Client Links to LSD

In step 530, the client initiates communication with the LSD using a client-to-vendor wireless communication pathway 255 via a hand-held or wearable communication or computing device such as a PDA or WIA that is enabled for wireless communication.

Step 540: Client Orders Merchandise and/or Services

In step 540, the client orders the offered goods and/or services via access to vendor Internet site 105.

Step 550: Client Submits Payment and Shipping Information

In step 550, payment for goods and/or services occurs immediately from a credit card number transmitted from the client to the vendor via wireless communication pathway 255. The client may also provide shipping information at this point. Additionally, an electronic receipt may be transmitted to the client from the vendor via wireless communication pathway 260. It is assumed that all such two-way transmissions of confidential information are encrypted for security as is well known to those practiced in the art of digital communications.

Step 560: Client Terminates Link

In step 560, the client terminates communication with the LSD.

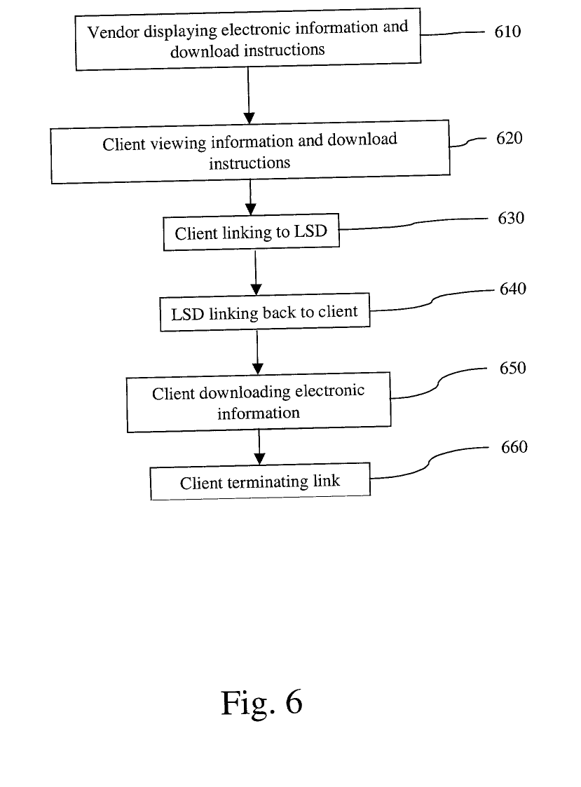

FIG. 6 illustrates an exemplary method of operation for downloading electronic information from a large screen interactive display. This method includes the following steps:

Step 610: Vendor Displays Electronic Information and Download Instructions

In step 610, the vendor transmits and displays information deemed to be important to the client, e.g., business hours, weather information, flight schedules, or stock prices.

Step 620: Client Views Information and Download Instructions

In step 620, the client views the information offered on the large screen display and reads the directions for selecting and downloading the desired information.

Step 630: Client Links to LSD

In step 630, the client initiates communication with the LSD using client-to-vendor wireless communication pathway 255 via a hand-held or wearable communication or computing device such as a PDA or WIA that is enabled for wireless communication.

Step 640: Vendor Links Back to Client Via LSD

In step 640, the LSD initiates communication back to the client using the same type of wireless communication pathway initiated by the client, which may be infrared, ultrasonic, visible or radio frequency electromagnetic radiation, or any other means of wireless communication.

Step 650: Client Downloads Electronic Information

In step 650, the client first renders payment for the information (if required by the vendor) through the client's credit card information or established account data. It is assumed that all such two-way transmissions of confidential information are encrypted for security as is well known to those practiced in the art of digital communications. The client then follows the given instructions and downloads the desired electronic information into the PDA or WIA data storage memory for immediate or later use.

Step 660: Client Terminates Link

In step 660, the client terminates communication with the LSD.

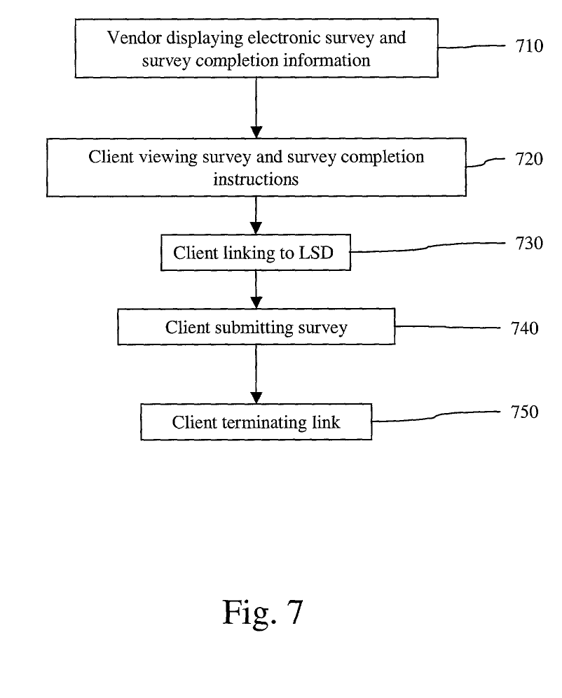

FIG. 7 illustrates an exemplary method of operation for conducting an electronic survey via a large-screen interactive display. This method includes the following steps:

Step 710: Vendor Displays Electronic Survey and Survey Completion Information

In step 710, the vendor displays an electronic survey on an LSD. This might be a product preference-survey, political poll, or a general interest questionnaire. The survey could be downloadable to the client's device such as a PDA or WIA.

Step 720: Client Views Survey and Survey Completion Instructions

In step 720, the client views the survey and the survey completion instructions.

Step 730: Client Links to LSD

In step 730, the client initiates communication to the LSD using client-to-vendor wireless communication pathway 255 via a hand-held or wearable communication or computing device such as a PDA or WIA that is enabled for wireless communication.

Step 740: Client Submits Survey

In step 740, the client answers the survey questions using a PDA or WIA and submits the completed survey to the LSD using client-to-vendor wireless communication pathway 255. The survey information is then routed to the vendor Internet site 105 for processing and storage.

Step 750: Client Terminates Link

In step 750, the client terminates communications with the LSD.

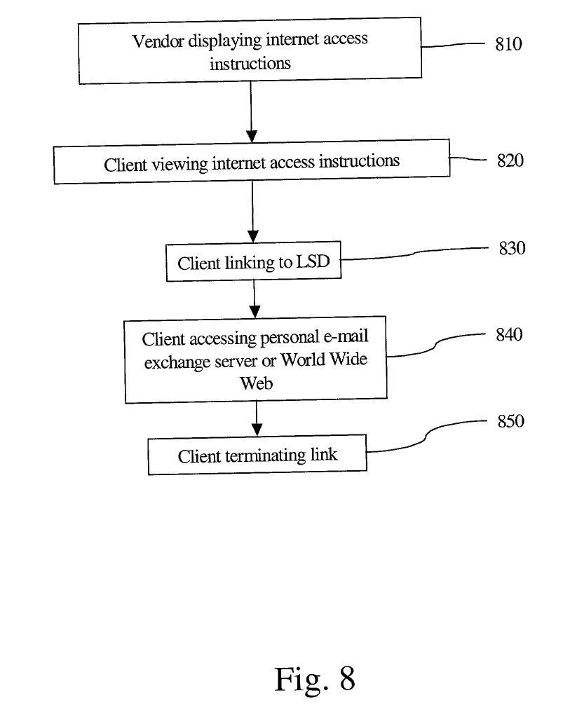

FIG. 8 illustrates an exemplary method of operation for accessing e-mail and/or accessing the Internet via a large-screen interactive display. This method includes the following steps:

Step 810: Vendor Displays Internet Access Instructions

In step 810, the vendor displays to an LSD instructions to the client outlining how to connect to the Internet via the LSD, including access and connect time charges (if any).

Step 820: Client Views Internet Access Instructions

In step 820, the client views the Internet access instructions.

Step 830: Client Links to Display

In step 830, the client initiates wireless communication with the LSD using client-to-vendor wireless communication pathway 255 via a hand-held or wearable communication or computing device such as a PDA or WIA that is enabled for wireless communication.

Step 840: Client Accesses a Personal E-mail Exchange Server or the Internet

In step 840, the client submits the appropriate URL's to access his/her specific e-mail exchange server. After e-mail is downloaded, it will appear on the PDA or WIA display. Alternatively, the client may use the LSD to browse the Internet by submitting any legitimate URL address.

Step 850: Client Terminates Link

In step 850, the client terminates communications with the LSD.

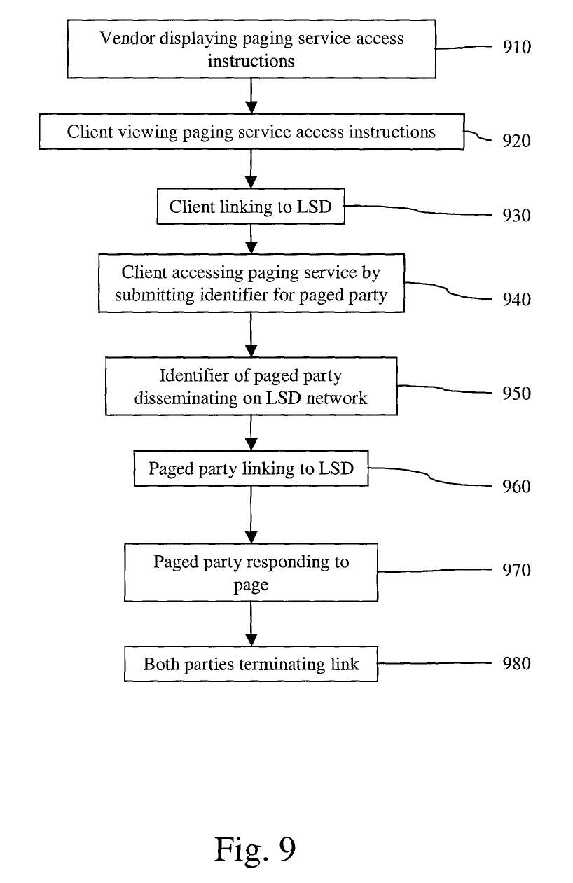

FIG. 9 illustrates an exemplary method of operation for accessing and using paging services via an LSD. This method includes the following steps:

Step 910: Vendor Displays Paging Service Access Instructions on an LSD

In step 910, the vendor displays instructions to the client outlining how to access paging services via the LSD.

Step 920: Client Views Paging Service Access Instructions

In step 920, the client views the paging service access instructions on the LSD.

Step 930: Client Links to LSD

In step 930, the client initiates wireless communication to the LSD using client-to-vendor wireless communication pathway 255 via a hand-held or wearable communication or computing device such as a PDA or WIA that is enabled for wireless communication.

Step 940: Client Accesses Paging Service by Submitting Identifier for Paged Party

In step 940, the client submits an identifier for the paged party. This could be a name, an image of the party, or an identification code.

Step 950: Identifier of Paged Party Disseminated on LSD Network

In step 950, the submitted identifier for the paged party is displayed on the network of LSDs. The identifier may be displayed continuously or at intervals until the paged party responds or the message “times out.”

Step 960: Paged Party Links to Display

In step 960, the paged party initiates wireless communication with the LSD through a device such as a PDA or WIA.

Step 970: Paged Party Responds to Page

In step 970, the paged party submits a response to the page. This might be a reply message or a location indicator. At this time the LSD network discontinues display of the paged party identifier.

Step 980: Both Parties Terminate Link

In step 980, both the paging and paged parties terminate communications with the LSD. Alternatively, the paging party may terminate his/her link immediately after the page has commenced.

The exemplary methods of operation described in FIGS. 4-9 are meant to capture the spirit of the invention and its range of possible uses but not to limit the range of uses to only these transactions.

A payment option can be incorporated by the vendor into any or all of the methods of operation described in FIGS. 4-9. This is done after the client initiates wireless communication with the LSD, by downloading a request to the client to submit credit card or billing information before goods and/or services are rendered. It is assumed that all such two-way transmissions of confidential information are encrypted for security as is well known to those practiced in the art of digital communications.

Advantages of the present invention include one or more of the following. One advantage of the present invention is that it allows for confidential, two-way wireless communication between client and vendor. A second advantage of the present invention is that it provides clients with customized advertising and marketing content, derived from direct interaction between client and vendor. A third advantage of the present invention is that it provides a means for direct and immediate feedback from the client to the vendor.

It is to be understood that the invention is not limited in its application to the details of construction and to the arrangements of the components set forth herein the following or illustrated in the drawings. The invention is capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

The invention claimed is:

1. A method of providing communication between a vendor and a client, comprising:
(a) displaying content on a large-screen display apparatus, the large-screen display apparatus including a transmitter and a receiver;
(b) receiving, via the receiver, a first message from a client, the first message responsive to the content; and
(c) transmitting, via the transmitter, a second message, the second message being responsive to the first message.
